(19) United States
(12) Patent Application Publication
(10) Pub. No.: US 2011/0091040 A1
(43) Pub. Date: Apr. 21, 2011

(54) METHOD FOR PERSONALIZING A SAFETY ELEMENT OF A MOBILE TERMINAL DEVICE

(76) Inventors: Ralph Krysiak, Markt Schwaben (DE); Werner Ness, Unterschleissheim (DE); Christian Garbers, Gossau (CH); Dirk Wacker, Muenchen (DE)

(21) Appl. No.: 12/995,731

(22) PCT Filed: Jun. 5, 2009
(86) PCT No.: PCT/EP2009/004044

§ 371 Date: Dec. 2, 2010

(30) Foreign Application Priority Data
Jun. 6, 2008 (DE) 10 2008 027 043.1

(51) Int. Cl. H04L 9/08

(52) U.S. Cl. 380/283

(57) ABSTRACT

The invention relates to a method for personalizing a security element (SE) of a mobile end device (EG), in particular in the form of a smart card chip of a communication end device. The invention comprises the pre-personalizing of the security element (SE) within the framework of its production process and the final personalizing of the security element (SE) upon the first-time use of the end device (EG) by a user (N), wherein a communication link is established between the end device (EG) and a trust center (TC) of a communication network operator. Within the framework of the pre-personalization of the security element (SE), a master key (MK) unique to the security element (SE) is ascertained and transmitted to the trust center (TC). Within the frame-work of the final personalization of the security element (SE), personal data of the user are transmitted upon the first-time use of the end device (EG) to the trust center (TC) and linked there with the master key (MK) to form a modified master key (MK). The security element (SE) is personalized with the modified master key (MK).

This invention relates to a method for personalizing a security element of a mobile end device, in particular in the form of a smart card chip of a communication end device. The method comprises the steps of pre-personalizing the security element within the framework of its production process and finally personalizing the security element upon the first-time use of the end device by a user, wherein a communication link is established between the end device and a trust center of a communication network operator.

Upon the personalization of the security element of the mobile end device it is assumed that the security element is located in the end device at the time of personalization. The security element can be firmly integrated into the end device here. Likewise, the security element can be implemented in a card or component which can be inserted into the end device. It basically plays no part in the proposed method whether the security element is employed in a card, e.g. a SIM card, or the mobile end device having the security element.

The term “security element” will be understood to be in particular a smart card chip or an intelligent microprocessor. A mobile end device will be understood to include all devices that communicate for example via GSM, UMTS, CDMA or similar networks on a corresponding communication network, i.e. in particular mobile phones, PDAs and the like.

When the security element is arranged e.g. in a chip card, a conventional way of personalizing the security element is to equip it with the operating system at the manufacturer of the security element and thereafter personalize it in a secure environment at the manufacturer of the chip card. This conventional way is no longer possible as soon as the security element, as explained at the outset, is an integrated part of the end device. For security reasons it would be desirable if the known two-way split, production of the security element and incorporation of the operating system at one place and personalization of the security element at another, secure place, could also be maintained in the case of a different design.

In this connection, EP 1 002 440 B1 discloses a method for customer-side personalization of GSM chips via an over-the-air interface. A chip pre-personalized by a network operator is finally personalized automatically when the subscriber logs into a subscriber network for the first time with his end device containing the chip. Upon final personalizing, after a connection has been set up between the end device and a trust center of the network operator, a new, second secret key is negotiated with the trust center and subsequently transmitted to the end device for incorporation into the chip. The second step of final personalizing is executed here by the subscriber with the help of the device via an identification center. A disadvantage of this procedure is that the manufacturer of the chip must already incorporate initial card-related data into the chip.

It is further known from EP 1 860 840 A2 to have the personalization conducted completely by the user of the end device via a trustworthy authority. For this purpose, identification data necessary for personalization are transferred by the user into the security module of the (telecommunication) end device. This can be done for example by manual input of alphanumeric digits. The personalization method is continued by the end device establishing communication with a trust center, a trustworthy authority. In a first step of the personalization method here, the identification data are transferred to the trust center. The trust center evaluates the received identification data for correctness and, in the positive case, sets up a secure connection with the end device. The trust center infers from the identification data which personalization data the user requires, and initiates a transfer of said data to the security module of the end device. After the transfer of the personalization data, the end device is restored to a normal operating mode and can be used for the intended communication purposes.

Starting out from this prior art, it is the object of the present invention to state a method for personalizing a security element of a mobile end device which permits the two-way split of production of the security element or incorporation of the operating system at one secure place and personalization at another, secure place to be maintained, whereby this should be achievable in cost-efficient fashion.

This object is achieved by a method having the features of claim 1. Advantageous embodiments result from the dependent claims.

The invention provides a method for personalizing a security element of a mobile end device which is configured in particular in the form of a smart card chip of a communication end device and comprises the steps of pre-personalizing the security element within the framework of its production process and finally personalizing the security element upon the first-time use of the end device by a user, wherein a communication link is established between the end device and a trust center of a communication network operator. According to the invention, within the framework of the pre-personalization of the security element, a master key unique to the security element is ascertained and transmitted to the trust center. Within the framework of the final personalization of the security element, personal data of the user are transmitted upon the first-time use of the end device to the trust center and linked there with the master key to form a modified master key. Finally, the security element is personalized with the modified master key.

The ascertainment of the master key unique to the security element permits the security element to be already individualized by the manufacturer. Thus, it is possible to do without delivery of the security elements to a completion site with the resulting production steps. The method according to the invention thus permits the personalizing of a security element which is integrated into the hardware of an end device and no longer permits the conventional method steps upon the production at specially secured places of production.

In particular, the ascertainment of the master key is effected when the security element is energized for test purposes during its production. It is particularly preferable that the ascertainment of the master key is effected when the security element is energized for the first time during its production. An especially efficient manufacture results when the ascertainment of the master key is effected as long as the security element is still present in the wafer sandwich during its production. This ensures an efficient chip individualization, on the one hand. On the other hand, the chip individualization is effected at an earliest possible time. The ascertainment of the master key can be effected e.g. before or after the sending of an ATR (answer to reset) command or an ATS (answer to select) command. The ascertainment of the master key could also be launched by the sending of a command, whereby a certain command can be provided therefor, or the first command sent is employed as a trigger. The master key can be configured e.g. in the form of a cryptographic key, an initial value for a deterministic random generator, an initial value for one or several counter objects, or a password.

In a further expedient embodiment, the master key is formed from at least two partial keys, the first partial key being contained in an operating system for the security element, and the second partial key in a key of the place of production. The key of the place of production is also designated as the fab key. Due to the fact that the master key also carries information about the place of production, the unique allocation of a master key is reliably guaranteed even in the case of several places of manufacture.

It is further expedient when there is associated with the security element, during production, a serial number which is stored in a memory of the security element. It is further provided that there is generated from the master key and the serial number, during the production of the security element, an individual key which is stored in the memory of the security element. The ascertainment of the individual key, in particular by the operating system incorporated into the security element, constitutes a test function. On the basis of this information it is possible to check the authenticity of the security element in a simple fashion upon final personalization. For this purpose, there is effected within the framework of the final personalization of the security element, within the framework of a further embodiment, an authentic readout of the serial number from the memory of the security element after the input of the user's personal data, said serial number being transferred to the trust center in particular together with the personal data of the user of the end device and the application to be personalized. According to a further embodiment, the authenticity of the serial number can then be checked by the trust center, and the individual key be derived from the master key stored in the trust center and from the serial number.

The user's personal data can, according to a variant, be input to a terminal connected communicatively to the trust center. The data transfer from the terminal to the trust center can be effected via line or cable-free. Alternatively, the user's personal data can be input to the end device having the security element, whereby they are then transferred to the terminal in particular via an over-the-air interface.

According to a further embodiment, in the trust center an application is personalized with the modified master key and transferred to the end device. The application can be already stored in the trust center. Likewise, the application can be transferred from the end device to the trust center within the framework of the final personalization, as explained above. In particular, the personalized application is transferred to the end device via an over-the-air interface.

The invention will be described more closely hereinafter with reference to the figures. Therein are shown:

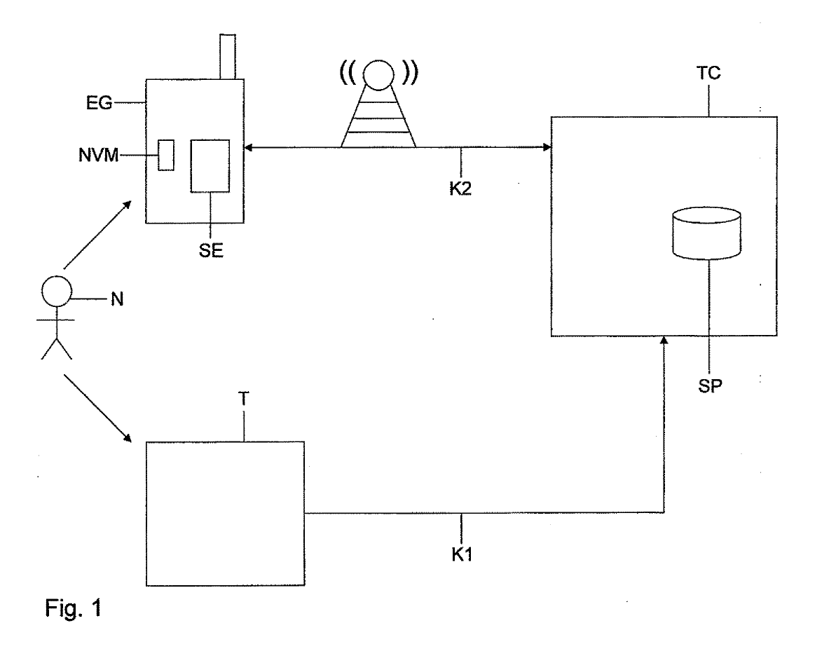

FIG. 1 a schematic representation of the system underlying the method according to the invention,

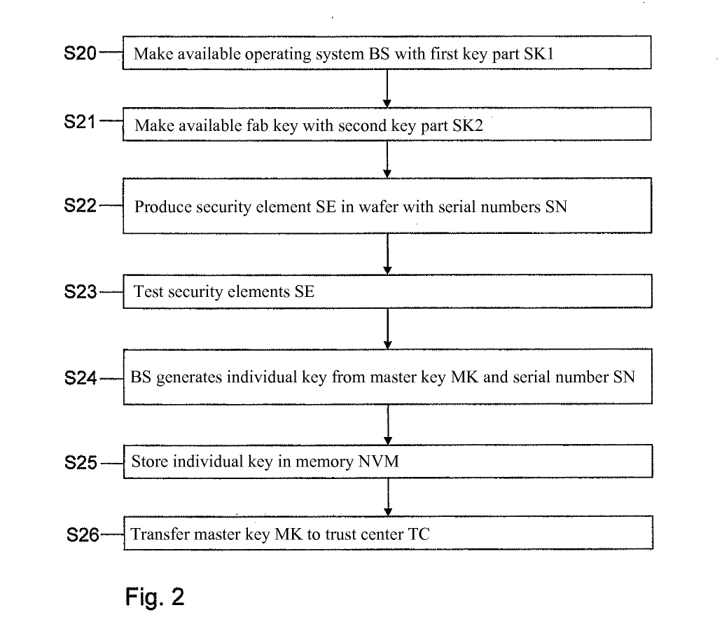

FIG. 2 a first flowchart illustrating the ascertainment of the master key within the framework of the pre-personalization, and

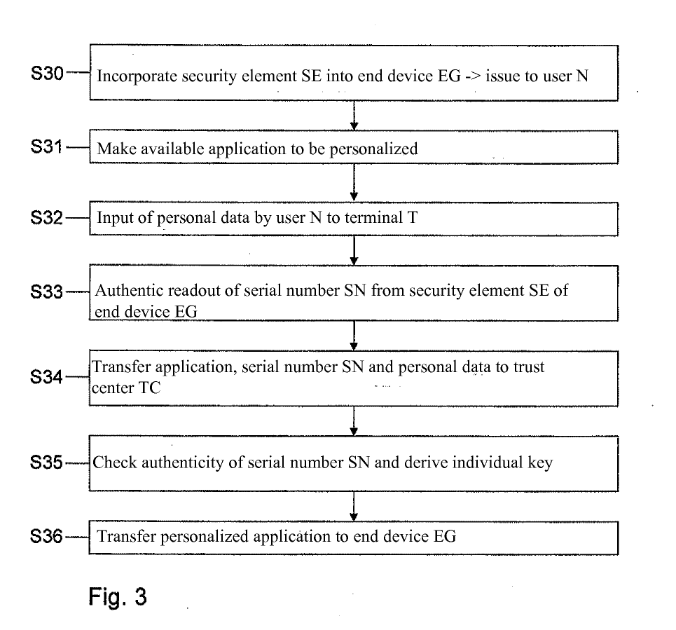

FIG. 3 a second flowchart illustrating the final personalization of the security element after issue of the end device containing the security element to a user.

The method according to the invention for personalizing a security element SE of a mobile end device EG is composed substantially of two steps: pre-personalizing the security element SE within the framework of its production process (depicted in FIG. 2), and finally personalizing the security element SE upon the first-time use of the end device EG by a user N (depicted in FIG. 3). The security element SE can be configured for example by a smart card chip. The end device EG can be e.g. a telecommunication end device which can communicate via GSM, UMTS, CDMA or similar networks on a corresponding communication network. In particular, the end device can thus be a mobile radio end device, a PDA, or in general a computer.

Within the framework of the pre-personalization, the security element SE is individualized, this being effected within the framework of the production of the security element SE together with ROM software (so-called embedded software). The pre-personalization or the chip individualization can be effected e.g. upon the initial start-up of the security element, when the security element, preferably still present in the wafer sandwich, is first supplied with voltage by the manufacturer. The individualization can be effected for example before or after the sending of an ATR/ATS command. The individualization could further be launched by the sending of an arbitrary command or one provided for this procedure. The individualization can generate e.g. cryptographic keys, initial values for a deterministic random number generator, initial values for counter objects (e.g. for secure messaging), or passwords (e.g. TANs).

The manufacturer of the security element SE is provided by a software manufacturer with the ROM software and further software, e.g. EEPROM software, which jointly provide the later complete functionality of the security element SE. The functionality can comprise for example JavaCard 2.2.1 and Global Platform 2.1.1. Secrets SK1 are contained in the ROM software and SK2 in the EEPROM software which are employed for creating a master key. Within the framework of the production of the security element, the ROM software and the EEPROM software are incorporated into the security element SE together with a serial number SN as values individual to the chip. Alternatively, the serial number SN can be generated in the security element itself from CPLC data present in the security element. Alternatively, data individual to the chip can be derived from an incorporated fab key individual to the chip. When the security element is supplied with voltage for the first time, there are generated, inter alia, an encryption key S-ENC=Hash (SK|SK2|SN|01) which corresponds to the master key MK, and an authentication key S-MAC=Hash (SK1|SK2|SN|02).

The pre-personalization of the security element SE is thus based on ascertaining a master key MK unique to the security element and transmitting it to a trust center TC, i.e. a trustworthy authority, for the further final personalization. The ascertainment of the master key MK is effected according to a variant depicted schematically in FIG. 2 by making available an operating system BS with a first key part SK1 (step S20) and making available a so-called fab key, i.e. a key of the place of production, which comprises a second key part SK2 (step S21). Subsequently there is effected in step S22 the production of the security element SE in the wafer with respective serial numbers SN. To check the operability of the security elements SE still present in the wafer sandwich, there follows according to step S23 a test of the security elements SE. This involves an at least one-time energizing of, or supply of voltage to, the security element, whereby the ascertainment of the master key MK from the first and second key parts SK1, SK2 is preferably already effected upon the first energizing in step S23. Further, the operating system BS generates in step S24 an individual key (test function) from the master key MK and the serial number SN. Said individual key is stored in step S25 in a memory NVM of the security element SE or of the end device EG. Finally, there is effected in step S26 the transfer of the master key MK to the trust center TC. The transfer of the master key MK to the trust center TC can be effected in arbitrary fashion.

In a variant of the above-described pre-personalization, the manufacturer transmits to the trust center TC not the master key MK, but the key parts SK1, SK2 as well as the serial number SN. The trust center TC then itself performs the generation of the master key MK.

The thus prepared security element SE is incorporated into an end device EG. Subsequently, the issue to a user is effected (step S30 in FIG. 3). In step S31 an application to be personalized is made available. It can be contained for example in a terminal T to which the user N has access (cf. FIG. 1). On the terminal T there is more-over effected the input of personal data by the user N (step S32). Alternatively, the application to be personalized can also be made available in the end device EG. Likewise, the user's personal data can be input in the end device EG.

According to step S33, a readout of the serial number SN from the security element SE is effected in the end device EG. The application to be personalized, the serial number SN and the personal data of the user N are then transferred from the terminal T to the trust center TC (step S34). In FIG. 1 this is marked by the reference sign K1. In the trust center TC there is effected a check of the authenticity of the serial number SN. Further, there is effected a derivation of the individual key from the master key MK of the security element SE already stored in a memory SP of the trust center TC, and the serial number SN. Subsequently, there is effected a transfer of the application personalized with the master key and the personal data of the user N to the end device EG, whereby an over-the-air interface can be used therefor. In FIG. 1 this is marked by the reference sign K2.

The invention has the advantage that the ascertainment of a master key associated with a security element is effected during the production of the security element. Said master key transmitted to a trust center is then, after the presentation of user-based data, employed for personalizing an application together with said data. This dispenses with an individual key export for each single one of security elements, because only the master key must be transferred to the trust center.

### LIST OF ITEMS

SE Security element
EG End device
N User
TC Trust center
MK Master key
SK1 First partial key
SK2 Second partial key
SN Serial number
NVM Memory
T Terminal
SP Memory
K1 Data transfer
K2 Data transfer
S20 Method step
S21 Method step
S22 Method step
S23 Method step
S24 Method step
S25 Method step
S26 Method step
S30 Method step
S31 Method step
S32 Method step
S33 Method step
S34 Method step
S35 Method step
S36 Method step

1-14. (canceled)

15. A method for personalizing a security element of a mobile end device such as a smart card chip of a communication end device, comprising the steps:
pre-personalizing the security element within the framework of its production process;
finally personalizing the security element upon the first-time use of the end device by a user, including establishing a communication link is established between the end device and a trust center of a communication network operator;
forming a master key within the framework of pre-personalization, when the security element is being energized for test purposes during its production, said master key being formed from at least two partial keys, the first partial key being contained in an operating system for the security element, and the second partial key being contained in a key of the place of production (fab key);
generating an individual key from the master key and a serial number by the security element and storing the individual key in a memory of the security element;
transmitting the master key to the trust center;
within the framework of the final personalization of the security element, upon the first-time use of the end device, transmitting the serial number and personal data of the user to the trust center and linking the stored master key therewith to form a modified master key;
deriving the individual key from the stored master key and the serial number by the trust center; and
personalizing the security element with the modified master key.

16. The method according to claim 15, wherein, within the framework of the pre-personalization of the security element, a master key is ascertained and transmitted to the trust center, and the user's personal data transmitted to the trust center within the framework of the final personalization upon the first-time use of the end device are linked in the trust center with the master key to form a modified master key.

17. The method according to claim 16, including generating the serial number from data present in the security element.

18. The method according to claim 15, including ascertaining the master key when the security element is energized for the first time during its production.

19. The method according to claim 15, wherein the ascertainment of the master key is effected as long as the security element is still present in the wafer sandwich during its production.

20. The method according to claim 15, including associating with the security element during production a serial number which is stored in a memory of the security element.

21. The method according to claim 20, wherein, within the framework of the final personalization of the security element, after the input of the user's personal data, effecting an authentic readout of the serial number from the memory of the security element, and transferring said serial number to the trust center together with the personal data of the user of the end device and the application to be personalized.

22. The method according to claim 15, wherein the authenticity of the serial number is checked by the trust center.

23. The method according to claim 15, wherein the user's personal data are input to a terminal communicatively connected to the trust center.

24. The method according to claim 15, including inputting the user's personal data to the end device having the security element.

25. The method according to claim 15, including personalizing an application in the trust center with the modified master key and transferring the personalized application to the end device.

26. The method according to claim 25, wherein the personalized application is transferred to the end device via an over-the-air interface.
